(19) United States
(12) Patent Application Publication
(10) Pub. No.: US 2026/0259681 A1
(43) Pub. Date: Sep. 3, 2026

(54) COMPOSABLE MEMORY RANKS FOR FULL DUPLEX MEMORY

(71) Applicant: Rambus Inc., San Jose, CA (US)

(72) Inventor: Christopher Haywood, Fernandina Beach, FL (US)

(21) Appl. No.: 19/163,375

(22) PCT Filed: Mar. 12, 2024
(86) PCT No.: PCT/US24/19563

§ 371 Date: Sep. 8, 2025

Related U.S. Application Data
(60) Provisional application No. 63/490,023, filed on Mar. 14, 2023.

(51) Int. Cl. G06F 3/06

(52) U.S. Cl. CPC G06F 3/0659; G06F 3/061; G06F 3/0631; G06F 3/0683

(57) ABSTRACT

A memory system includes a memory controller, a plurality of serial data buffers, and a plurality of memory devices. The memory controller includes rank configuration logic for composing ranks of memory devices and Memory Controller corresponding serial communication lanes. In different configurations, the ranks may be of varying sizes to accommodate different data widths and/or different levels of striping across memory devices. The memory controller may dynamically change the rank configuration by re-assigning the serial communication lanes to different memory ranks.

### BACKGROUND

Memory systems typically include a memory controller and a set of memory devices each comprising one or more arrays of memory cells. The memory controller sends commands to the memory devices to facilitate writing data to the memory devices and reading data from the memory devices.

### BRIEF DESCRIPTION OF THE DRAWINGS

The teachings of the embodiments herein can be readily understood by considering the following detailed description in conjunction with the accompanying drawings.

FIG. 1 is a block diagram illustrating an example embodiment of a memory system.

FIG. 2 is a block diagram illustrating a logical architecture of a memory system with composable ranks.

FIG. 3 is an example embodiment of a memory controller for a memory system with composable ranks.

FIG. 4 is a flowchart illustrating an example embodiment of a process for operating a memory controller for a memory system with composable ranks.

### DETAILED DESCRIPTION

A memory system includes a memory controller, a plurality of serial data buffers, and a plurality of memory devices. The memory controller includes rank configuration logic for composing ranks of memory devices and corresponding serial communication lanes. In different configurations, the ranks may be of varying sizes to accommodate different data widths and/or different levels of striping across memory devices. The memory controller may dynamically change the rank configuration by re-assigning the serial communication lanes to different memory ranks.

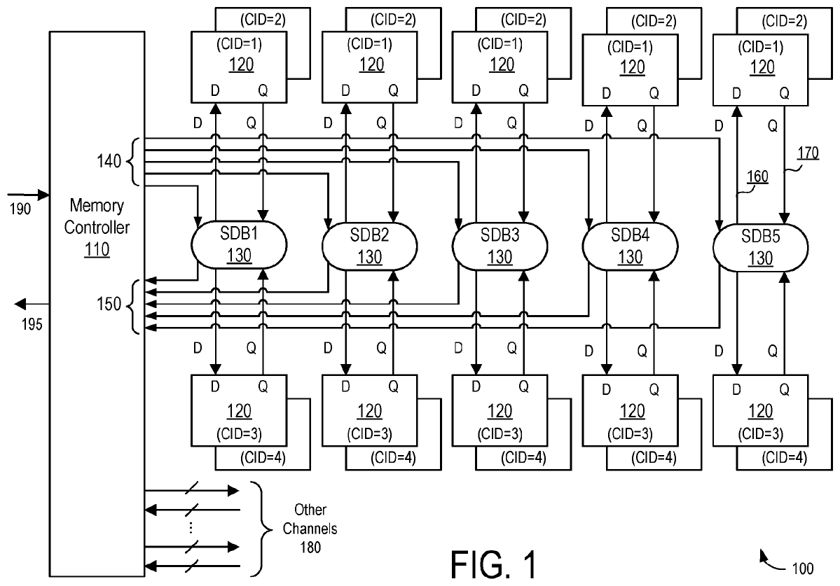

FIG. 1 illustrates an embodiment of a memory system 100 comprising a memory controller 110, a plurality of serial data buffers 130, and a plurality of memory devices 120. In one embodiment, the memory controller 110, the serial data buffers 130, and the memory devices 120 may be implemented as separate dies within the same package. In other embodiments, they are implemented in their own respective packages. The serial data buffers 130 and memory devices 120 may be embodied as respective integrated circuits mounted on a common printed circuit board of a memory module. In further embodiments, the memory system 100 may comprise a disaggregated memory system 100 in which the serial data buffers 130 and memory devices 120 are physically remote from the memory controller 110 and may be distributed at different locations. Furthermore, serial data buffers 130 and their connected memory devices 120 may be physically remote from each other within the same memory system 100.

The memory controller 110 receives a set of host-side input packets via a host-side input link 190 and sends serial commands and write data to a set of serial data buffers 130 via respective downstream serial communication links 140. The memory controller 110 also receives read data from the serial data buffers 130 via respective upstream serial communication links 150, and outputs host-side output packets including the read data via the host-side output link 195. In an embodiment, the host-side input packets received via the host-side input link 190 and the host-side output packets sent via the host-side output link 195 may conform to an OpenCAPI, Compute Express Link (CXL), or other serial attached memory communication protocol.

The serial commands sent via the downstream links 140 to the serial data buffers 130 may be formatted as packetized commands having a header portion specifying a type of command (e.g., write, read, refresh, etc.) and a content portion specifying a memory address (for read/write command), or other information associated with commands. For write operations, the memory controller 110 furthermore sends packetized write data via the downstream communication links 140 which may include varying allocations of write data, metadata, and/or error correction data. In response to read commands, the memory controller 110 receives packetized read data from the set of serial data buffers 130 via respective upstream communication links 150, which may similarly include varying allocations of read data and other data types such as metadata, error correction data, etc.

In the illustrated embodiment, the downstream links 140 and upstream links 150 represent a single memory channel coupled with a set of serial data buffers 130. The memory controller 110 may similarly communicate with additional sets of serial data buffers 130 and corresponding memory devices 120 (not shown) via other channels 180. For example, in one implementation, the serial data buffers 130 and memory devices 120 are arranged in one or more memory modules (such as dual-inline memory modules or other form factor memory modules) that may have varying numbers of channels coupled to the memory controller 110.

The serial data buffers 130 buffer and decode the commands and write data received via the downstream communication links 140 and send corresponding commands and write data to the memory devices 120 via unidirectional input lines (D) 160. In response to read commands, the serial data buffers 130 read from the memory devices 120 via unidirectional output lines (Q) 170 and transfer the read data to the memory controller 110 via the upstream communication links 150.

The memory devices 120 have separate unidirectional input ports (D) and unidirectional output ports (Q) that enable the memory devices 120 to receive input commands or write data at the input port D while concurrently outputting read data on the output port Q. The memory devices 120 may comprise, for example, full duplex Dynamic Random Access Memory (DRAM) devices, FLASH memory devices, or other types of memory devices. Each memory device 120 is identified by a chip identifier (CID) (or alternatively, a package identifier (DDPID)). The memory devices 120 each include one or more memory bank groups comprising a set of memory banks. Each of the memory banks comprises a two-dimensional array of memory cells organized into rows and columns. Thus, the memory address of an individual memory cell may be characterized by a chip identifier, a bank group, a bank address, a row address, and a column address.

A single serial data buffer 130 may be coupled over shared D lines 160 and Q lines 170 to multiple memory devices 120 having different CIDs. For example, in the illustrated embodiment, there are five serial data buffers 130 shown that each couple to four different memory devices 120 (having CIDs 1:4) via shared D lines 160 and Q lines 170. In this configuration, a serial data buffer 130 may select between the memory devices 120 during a memory operation based on a CID in a received command from the memory controller 110.

Memory devices 120 sharing the same CID that are coupled to different serial data buffers 130 may be accessed concurrently in a single memory operation. In alternative configurations, the memory system 100 may have a different number of serial data buffers 130 and/or a different number of memory devices 120 coupled to each of the serial data buffers 130.

In an example architecture, the memory devices 120 and serial data buffers 130 may include various control pins (not shown) coupled by respective control links to enable selection between the different memory devices 120 coupled to a shared serial data buffer 130. For example, the control pins of each memory device 120 may include a command chip select (CCS), write data chip select (DCS), and read data chip select (QCS) coupled to respective pins of the serial data buffer 130 (per memory device 120). In the illustrated embodiment, the serial data buffers 130 may each include control pins DCS[4:1], CCS[4:1], and QCS[4:1] for coupling to memory devices 120 with CIDs 4:1 respectively. For incoming commands and write data associated with a specified CID, the serial data buffer 130 may assert the respective CCS (for commands) or DCS (for write data) pins associated with the CID to select the appropriate memory device 120. For outgoing read data, the memory device 120 may likewise assert the respective QCS pin so that the serial data buffer 130 can detect which CID to associate with the read data.

In the described configuration, each memory operation may be performed with respect to a logical rank that includes a set of concurrently accessed memory devices 120. In this configuration, data words are striped across the multiple memory devices 120 in a rank. Each rank is also associated with a set of serial data buffers 130 and a set of corresponding serial communication lanes (e.g., byte lanes) that include the set of communication links 140, 150 utilized for transferring commands and data to and from the respective memory devices 120 in a rank (e.g., one byte lane per memory device 120 in a rank). During a memory operation, each byte lane of a rank may be responsible for transferring one byte per memory device transfer period (e.g., single data rate or double data rate) for a respective memory device 120 in the rank.

In operation, the memory controller 110 issues the same read or write command referencing the same memory address to multiple serial data buffers 130 associated with a rank over their respective downstream communication links 140. Following a write command to a rank, the memory controller 110 sends different portions of the write data word through the set of downstream communication links 140 associated with the rank to the respective serial data buffers 130. The serial data buffers 130 write their respectively received portions of the write data word to one of the coupled memory devices 120 of the selected rank. Similarly, following a read command to a rank, each of the serial data buffers 130 in the rank reads from one of the coupled memory devices 120 in the selected rank to obtain different portions of the requested read data word. The serial data buffers 130 then each send the different portions of the read data word to the memory controller 110 via the respective upstream communication links 150.

Byte lanes may be shared between more than one rank. For example, the illustrated configuration may enable four ranks corresponding to CIDs 1:4 that each include five memory devices 120 and utilize five corresponding byte lanes. The set of five serial data buffers 130 and corresponding communication links 140, 150 corresponding to the five byte lanes are shared between each of the four ranks.

In FIG. 1, each serial data buffer 130 couples to the memory controller 110 via a single downstream communication link 140 and a single upstream communication link 150 (i.e., the byte lanes include single physical links). However, in alternative configurations, the memory controller 110 may be coupled to each serial data buffer 130 via two or more communication links 140, 150 (in each direction) that are logically bundled together to operate as single byte lanes. For example, a byte lane may comprise a pair of downstream communication 140 or upstream communication links 150, a triplet, or other number of links 140, 150.

The memory controller 110 may dynamically compose the groupings of communication links 140, 150, serial data buffers 130, and memory devices 120 into logical ranks that may each utilize a configurable number of byte lanes. This enables the memory controller 110 to change the number of ranks, the rank size, and/or change the assignments of particular memory devices 120 to each rank. For example, the memory controller 110 may change the rank configuration in response to configurable system or user parameters (e.g., relating to security, latency, bandwidth, metadata scheme, error correction scheme, etc.), in response to system components (e.g., virtual machines) being brought on-line or taken down, in response to failures, or in response to other dynamic configuration factors related to the computing environment where the memory system 100 resides. Moreover, the memory controller 110 may compose logical ranks without constraints on the physical locations of memory devices 120 in a rank. For example, memory devices 120 in a rank may be co-located on a same memory module, or memory devices 120 of a logical rank may be spread across different memory modules that are not necessarily co-located.

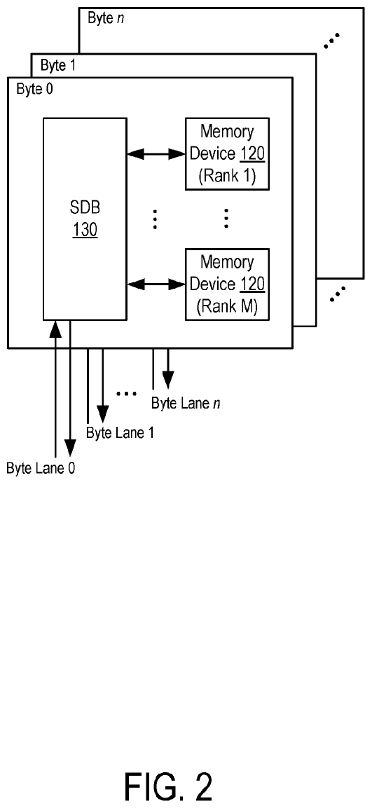

FIG. 2 illustrates a logical architecture of a full duplex memory system 100 with composable ranks. In the example of FIG. 2, the serial data buffer 130 is shared between M different memory devices 120 in different ranks. The width of the ranks is configurable by dynamically configuring the number of byte lanes per rank and assigning specific byte lanes to each rank. Based on the assignments, the memory controller 110 controls which set of communication links 140, 150 it utilizes for operations associated with a particular rank. For example, n byte lanes may be assigned to a rank, where each byte lane may comprise one or more downstream communication links 140 and one or more upstream communication links 150. In a write operation to a rank m, each transfer of the burst length communicates n bytes over the set of bundled downstream communication links 140 to the n different serial data buffers 130, which transfer the n bytes to the n different memory devices 120 of the rank m. Thus, the write data becomes striped over n different memory devices 120 in the rank m. In a read operation, each transfer of the burst length communicates n bytes from n different memory devices 120 to their respective serial data buffers 130, which then communicate the n bytes over one or more upstream communication links 150 assigned to the rank m.

To reconfigure the rank width, the bundled communication links 140, 150 may be reassigned to different ranks. For example, for a rank comprising six byte lanes (n=6), a bundle of six downstream communication links 140 and six upstream communication links 150 may operate together to communicate commands to six different memory devices 120 assigned to a rank m. To reconfigure the memory system 100 for ranks of three byte lanes (n=3), the same set of six communication links 140, 150 and six memory devices 120 be divided into two ranks of three memory devices 120 and three byte lanes each. To expand the rank size, a higher number of communication links 140, 150, serial data buffers 130, and corresponding memory devices 120 may be associated together in a rank.

The memory controller 110 may configure logical ranks with varying numbers of byte lanes to accommodate varying data sizes. For example, in one configuration, the memory system 100 may be configured with six byte lanes per rank with data striped across six different memory devices 120. Each byte lane may communicate 128 bits per operation to corresponding memory devices 120 (768 bits total per operation). This configuration may enable operations with 64 bytes of read or write data and 32 byes of error correction codes (ECC), metadata, and/or other data types, for example. In another example, the memory system 100 may be configured with five byte lanes per rank with data striped across five different memory devices 120. Each byte lane communicates 128 bits per operation (640 bits total), which may allow for 64 bytes of read or write data and 16 bytes of ECC, metadata, and/or other data types, for example. In another example, the memory system 100 may be configured with four byte lanes per rank with data striped across four different memory devices 120. Each byte lane communicates 128 bits per operation (512 bits total), which may allow for 64 bytes of read or write data (without ECC, metadata, or other extra data types), for example. Any of the above configurations may be utilized in a cache configuration with 64 cache lines and 4K pages, for example. In yet another configuration, the memory system 100 may be configured with three byte lanes per rank with data striped across three different memory devices 120. Here, each byte lane communicates 128 bits per operation (384 bits total), which may allow for 48 bytes of read or write data, ECC, metadata, or other data types per operation. This configuration may be utilized in a cache memory with smaller cache lines compared to the above examples. For example, a page configuration may utilize 64 cache lines with 3072 addressable bytes.

In an embodiment, various protection schemes may be employed by utilizing spare byte lanes and memory devices 120 that are reserved for use in event of a failure. If a memory device 120 fails, the memory controller 110 may dynamically reassign a spare byte lane and memory device 120 to the rank of the failed memory device 120.

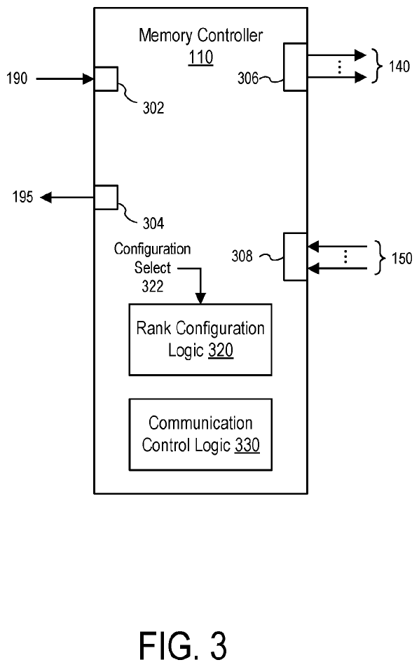

FIG. 3 illustrates an example embodiment of a memory controller 110 that enables composable ranks. The memory controller 110 includes a host-side input port 302 to receive inputs over the host-side input link 190, a host-side output port 304 to output over the host-side output link 195, a plurality of downstream serial communication ports 306 to communicate commands and write data over the downstream communication links 140 to the serial data buffers 130, a plurality of upstream serial communication ports 308 to receive read data from the upstream communication links 150, rank configuration logic 320, and communication control logic 330.

The rank configuration logic 320 dynamically assigns subsets of the downstream serial communication ports 306 (and corresponding downstream communication links 140) and upstream serial communication ports 308 (and corresponding upstream communication links 150) to operate as byte lanes for respective memory ranks. In some configurations, a set of serial communication ports 306, 308 and corresponding communication links 140, 150 may be shared between multiple different ranks of memory devices 120. In an embodiment, the rank configuration logic 320 may determine assignments based on a configuration select input 322 that may control one or more configuration aspects such as the number of ranks, the number of byte lanes per rank, the number of total bytes per memory transfer, the number of data bytes per memory transfer, the number of error correction code bytes per memory transfer, the number of metadata bytes per memory transfer, a page size, or other configurable characteristic of the memory system 100. In an embodiment, the configuration select input 322 may comprises an identifier that identifies a specific configuration from a set of predefined configuration attributes (e.g., using a look up table). The configuration select input 322 may be received from a host via the host-side input port 302 or separate control input, from a pre-configured register, from a physical switch, or from another input source. The configuration select input 322 may be hardwired or hardcoded at manufacture of the memory controller 110, or may be dynamically changed while the memory system 100 is deployed. The rank configuration logic 320 may store the rank configuration to an internal register that maps serial communication ports 306, 308 to memory ranks.

The communication control logic 330 facilitates read, write, and other memory operations in accordance with the rank configuration. For example, to facilitate a write operation to a rank, the communication control logic 330 communicates commands and write data over the subset of the downstream serial communication ports 306 associated with the rank in accordance with the assignments from the rank configuration logic 320. Here, the command may be sent on each of the downstream serial communication ports 306 associated with the rank so that all serial data buffers 130 and memory devices 120 associated with the rank receive the same command, and the write data may be striped across the different downstream serial communication ports 306. To facilitate a read operation from a rank, the communication control logic 330 communicates a read command (over each of the downstream serial communication ports 306 associated with the rank) and receives read data over the subset of the upstream serial communication ports 308 associated with the rank in accordance with the assignments from the rank configuration logic 320. The read data received from the set of upstream communication ports 308 may be combined by the memory controller 110.

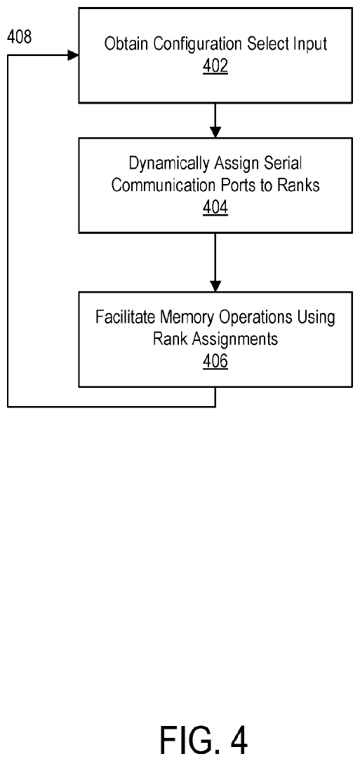

FIG. 4 illustrates an example embodiment of a method for operating a memory controller 110. The memory controller 110 obtains 402 a configuration select input for configuring composable memory ranks. The memory controller 110 dynamically assigns 404, based on the configuration select input, a subset of the downstream serial communication ports 306 and a subset of upstream serial communication ports 308 of the memory controller 110 to a memory rank. The memory controller 110 facilitates 406 memory operations of the memory rank based on the rank assignments. For example, for a write operation, the memory controller 110 communicates commands and write data over the subset of the downstream serial communication ports 306 assigned to the memory rank. For read operations, the memory controller 110 receives read data over the subset of upstream serial communication ports 308 assigned to the rank. The assignments may optionally be reconfigured 408 in response to an updated configuration select input.

Upon reading this disclosure, those of ordinary skill in the art will appreciate still alternative structural and functional designs and processes for the described embodiments, through the disclosed principles of the present disclosure. Thus, while embodiments and applications of the present disclosure have been illustrated and described, it is to be understood that the disclosure is not limited to the precise construction and components disclosed herein. Various modifications, changes and variations which will be apparent to those skilled in the art may be made in the arrangement, operation and details of the method and apparatus of the present disclosure herein without departing from the scope of the disclosure as defined in the appended claims.

What is claimed is:

1. A memory controller comprising:
a plurality of downstream serial communication ports to communicate commands and write data over a set of downstream communication links;
a plurality of upstream serial communication ports to receive read data over a set of upstream communication links;
rank configuration logic to assign, based on a configuration select input, subsets of the downstream serial communication ports and subsets of the upstream serial communication ports to respective serial communication lanes associated with respective memory ranks, each of the respective memory ranks comprising a set of memory devices having respective serial input ports for communicating with the downstream communication links and respective serial output ports for communicating with the upstream communication links; and
communication logic to facilitate read and write operations to a selected memory rank of memory devices by communicating commands and write data over a selected subset of the downstream serial communication ports assigned to the selected memory rank, and to receive read data over a selected subset of the upstream serial communication ports assigned to the selected memory rank.

2. The memory controller of claim 1, wherein the rank configuration logic is configured to receive an updated configuration select input and to dynamically reassign the subsets of the downstream serial communication ports and the subsets of the upstream serial communication ports to one or more different ranks.

3. The memory controller of claim 1, wherein the configuration select input controls a number of the serial communication lanes assigned to each of the respective memory ranks.

4. The memory controller of claim 1, wherein the configuration select input controls a number of bytes per memory operation.

5. The memory controller of claim 1, wherein the configuration select input controls an allocation of read or write data bytes, error correction code bytes, and metadata bytes per memory operation.

6. The memory controller of claim 1, wherein the configuration select input controls at least one of a number of cache lines and a page size associated with memory operations.

7. The memory controller of claim 1, wherein the plurality of downstream serial communication ports and the plurality of upstream serial communication ports are coupled to respective serial data buffers that communicate with the set of memory devices.

8. The memory controller of claim 1, wherein the selected memory rank of memory devices are physically distributed on different memory modules.

9. The memory controller of claim 1, further comprising:
a plurality of host side data ports to communicate with a host device via a serial attached memory communication protocol.

10. A method for operating a memory controller, comprising:
obtaining a configuration select input at a memory controller;
assigning, based on a configuration select input, respective subsets of downstream serial communication ports and a subsets of upstream serial communications ports of a memory controller to respective serial communication lanes associated with respective memory ranks, each of the respective memory ranks comprising a set of memory devices having respective serial input ports and respective serial output ports; and
facilitating read and write operations to a selected memory rank of memory devices by communicating commands and write data over a selected subset of the downstream serial communication ports assigned to the selected memory rank, and to receive read data over a selected subset of the upstream serial communication ports assigned to the selected memory rank.

11. The method of claim 10, further comprising:
receiving an updated configuration select input; and
dynamically reassigning the subsets of the downstream serial communication ports and the subsets of the upstream serial communication ports to one or more different ranks.

12. The method of claim 10, wherein the configuration select input controls a number of the serial communication lanes assigned to each of the respective memory ranks.

13. The method of claim 10, wherein the configuration select input controls a number of bytes per memory operation.

14. The method of claim 10, wherein the configuration select input controls an allocation of read or write data bytes, error correction code bytes, and metadata bytes per memory operation.

15. The method of claim 10, wherein the configuration select input controls at least one of a number of cache lines and a page size associated with memory operations.

16. A memory system comprising:
a plurality of memory devices having serial input ports and serial output ports;
a plurality of serial data buffers each coupled to buffer communications to and from one or more of the plurality of memory devices; and
a memory controller comprising:
a plurality of downstream serial communication ports to communicate commands and write data over a set of downstream communication links to the plurality of serial data buffers;
a plurality of upstream serial communication ports to receive read data over a set of upstream communication links from the set of serial data buffers;
rank configuration logic to assign, based on a configuration select input, subsets of the downstream serial communication ports and subsets of the upstream serial communication ports to respective serial communication lanes associated with respective memory ranks, each of the respective memory ranks comprising a subset of the plurality of memory devices; and
communication logic to facilitate read and write operations to a selected memory rank of memory devices by communicating commands and write data over a selected subset of the downstream serial communication ports assigned to the selected memory rank, and to receive read data over a selected subset of the upstream serial communication ports assigned to the selected memory rank.

17. The memory system of claim 16, wherein the rank configuration logic is configured to receive an updated configuration select input and to dynamically reassign the subsets of the downstream serial communication ports and the subsets of the upstream serial communication ports to one or more different ranks.

18. The memory system of claim 16, wherein the configuration select input controls a number of the serial communication lanes assigned to each of the respective memory ranks.

19. The memory system of claim 16, wherein subsets of the plurality of memory devices and the plurality of serial data buffers are co-located on memory modules, and wherein memory devices of the selected memory rank are physically distributed on different ones of the memory modules.

20. The memory system of claim 16, wherein the memory controller further comprises:
a plurality of host side data ports to communicate with a host device via a serial attached memory communication protocol.
